(19) United States
(12) Patent Application Publication
(10) Pub. No.: US 2014/0223958 A1
(43) Pub. Date: Aug. 14, 2014

(54) Clathrate desalination process using an ultrasonic actuator

(71) Applicants: Richard A. McCormack, La Jolla, CA (US); John A. Ripmeester, Ottawa (CA)

(72) Inventors: Richard A. McCormack, La Jolla, CA (US); John A. Ripmeester, Ottawa (CA)

(21) Appl. No.: 14/347,228

(22) PCT Filed: Sep. 26, 2012
(86) PCT No.: PCT/US2012/057392

§ 371 Date: Mar. 25, 2014

Related U.S. Application Data
(60) Provisional application No. 61/539,267, filed on Sep. 26, 2011.

(51) Int. Cl. C02F 1/22

(52) U.S. Cl. CPC C02F 1/22
USPC 62/533; 62/123

(57) ABSTRACT

A freeze desalination process uses cyclopentane (“C₅H₁₀”) (14) as an agent for the formation of a gas hydrate as a clathrate (13). A crystallizer vessel (10) containing a mixture of seawater (11) and diffuse bubbles (18) of C₅H₁₀ is cooled to allow a gas hydrate phase to form. An ultrasonic transducer (21) located in the bubble stream encourages nucleation and thus clathrate formation.

### PRIOR APPLICATION

This application claims the benefit of U.S. Provisional Application Serial No. 61539267, filed 2011-09-26.

### FIELD OF THE INVENTION

The present invention relates generally to desalination of seawater, and is particularly concerned with gas hydrate freeze desalination.

### BACKGROUND

Desalination is the process of removing salts and minerals from water so that it can be used for human consumption, irrigation, industrial processes and to pre-treat municipal and industrial wastewater prior to discharge. The intrigue of desalination is the high demand for fresh water and the limited supply of naturally occurring fresh water on the planet. There is an abundance of water on earth but only approximately 2.5% of the water is in the form of fresh water with the rest being in the form of salt water. Technologies that can cost effectively remove salts and minerals from the vast salt water supply have the potential to increase the supply of fresh water.

Various techniques have been proposed in the past for obtaining fresh water from seawater, but most of these have been higher cost processes that have had limited commercial feasibility. Historically, the original methods proposed for desalinating seawater involved distillation, where seawater is heated to the boiling point and the water vapor released is condensed as fresh water. In another process undesirable ions in water are exchanged for desirable ions as the water passes through granular chemicals, called ion exchange resins. This process is widely used to soften water and to manufacture high purity de-ionized water for specialty applications. However, this process is impractical for treating water with higher levels of dissolved solids. Later, reverse osmosis, involving the diffusion of fresh water from seawater through a semi-permeable membrane, was also developed for use where higher water prices were acceptable.

Concurrently, various processes were proposed for desalinating seawater by freezing. These processes, to the extent developed at that time, all proved to be too expensive for commercial use. Some of these processes involved indirect freezing, in which freezing is accomplished by circulating a cold refrigerant through a heat exchanger to remove heat from the seawater. Ice is formed on the heat exchanger surface and must be removed, washed and melted to produce fresh water.

Another category of freeze desalination is by direct freezing, in which heat is removed from seawater by direct contact with a refrigerant, which may be seawater itself, in a vacuum freezing vapor compression process, or alternatively, by use of a secondary refrigerant. In the latter process, a refrigerant (that has a low solubility in water) is compressed, cooled to a temperature close to the freezing temperature of salt water, and mixed with seawater. As the refrigerant evaporates, heat is absorbed from the mixture and the water freezes into ice. Butane is a possible secondary refrigerant for such a process.

Another type of direct freezing desalination process is called gas hydrate freeze desalination. This process involves the use of a class of agents that form gas hydrates in the form of clathrates, with water at temperatures higher than the normal freezing temperature of water. A clathrate is an aggregation of water molecules around a central hydrocarbon, or other non-water molecule, to form an ice crystal. When clathrate “ice” is melted, fresh water and the clathrate forming agent are recovered, thus producing fresh water and regenerating the clathrate forming agent simultaneously. This has an advantage over other direct freezing processes in that the operating temperature is higher, reducing power requirements to both form and melt the “ice.”

Various alternative proposals for freeze desalination are described in a paper entitled, “Desalination by Freezing” by Herbert Wiegandt, School of Chemical Engineering, Cornell University, March 1990. Several demonstration plants for conducting freeze desalination feasibility and economic testing were designed and constructed by the U.S. Department of the Interior, Office of Saline Water, from 1955 through 1974. However, these were discontinued due to lack of funds and to problems encountered in their operation. In spite of considerable research on clathrate freeze desalination for a number of years, it was not considered to be a commercially viable alternative, due to technical problems and high operating costs. Test plants built for clathrate freeze desalination did not meet design criteria, mainly because the hydrate crystals were very small and both difficult and expensive to separate from the brine.

An improved clathrate desalination process is described in my patent, U.S. Pat. No. 5,553,456, incorporated herein by reference. This process used the low temperature of deep seawater and one of a various number of halogenated hydrocarbon refrigerants as a clathrate forming agent. However, such refrigerants have been found to be unacceptably damaging to the environment, and have been banned by most governments. Clathrate forming gases other than the now banned halogenated hydrocarbon refrigerants have proven so far to be impractical.

Cyclopentane (“C₅H₁₀”), also known as pentamethylene, is an alicyclic hydrocarbon often used as a blowing agent in the manufacture of polyurethane insulating foam. This compound is nearly immiscible in water and thus does not readily form clathrates.

There is a need for an improved desalination process which addresses cost, energy efficiency, and environmental concerns.

### SUMMARY

The primary and secondary objects of the invention are to provide an improved desalination process. These and other objects are achieved by a clathrate formation process using sonic energy to help improve nucleation during clathrate formation.

The content of the original claims is incorporated herein by reference as summarizing features in one or more exemplary embodiments.

In some embodiments there is provided a method for desalination of water which comprises: providing an amount of seawater; cooling said amount to a phase which allows for clathrate formation; injecting a dispersed clathrate-forming gas agent into said amount; imparting ultrasonic energy into said amount; collecting clathrate crystals from said amount; and, melting said crystals to form an amount of fresh water.

In some embodiments the method further comprises augmenting said amount with a flow of additional seawater.

In some embodiments said injecting occurs through a gas diffuser to create a stream of bubbles of said gas agent.

In some embodiments said imparting comprises locating and activating an ultrasonic transducer within said amount.

In some embodiments said imparting comprises locating and activating an ultrasonic transducer within said stream.

In some embodiments said activating comprises operating said transducer at a frequency of between about 30 and 50 Kilohertz.

In some embodiments the method further comprises placing an amount of solid material particles within said stream.

In some embodiments said solid material particles comprises silica gel particles. In some embodiments said imparting comprises locating and activating an ultrasonic transducer within said stream; and, wherein said method further comprises: carrying said particles within a structure mounted to said transducer; wherein said structure comprises an array of apertures sized and shaped to contain said particles and allow passage of a portion of said stream therethrough.

In some embodiments said collecting comprises washing said crystals to remove residual seawater therefrom.

In some embodiments said melting comprises using residual heat generated by a compressor or chiller device associated with said apparatus.

In some embodiments said gas is selected from the group consisting of CO₂ , CH₄, C₂H₆, C₃H₈, C₄H₁₀ and C₅H₁₀ and gaseous mixtures thereof.

In some embodiments said cooling comprises prechilling an amount of cyclopentane by circulating it through a conduit exposed to an amount of chilled seawater.

In some embodiments there is provided a clathrate freeze desalination apparatus which comprises: a crystallizer reaction vessel; an amount of seawater located in said crystallizer; a source of clathrate forming gas; and, an ultrasonic transducer located to impart sonic energy upon said amount located within said vessel.

In some embodiments said gas is selected from the group consisting of CO₂, CH₄, C₂H₆, C₃H₈, C₄H₁₀ and C₅H₁₀ and gaseous mixtures thereof.

In some embodiments said amount is augmented by a flow of seawater into said vessel. In some embodiments the apparatus which further comprises: a diffuser connected to said source and adapted to form said gas into a stream of bubbles.

In some embodiments the apparatus further comprises: said diffuser being further adapted to generate bubbles in said stream having a mean diameter of between about 10⁻³ and 10⁻² millimeter.

### BRIEF DESCRIPTION OF THE DRAWINGS

FIG. 1 is a diagrammatic block diagram of the major components of an exemplary seawater clathrate formation system using cyclopentane as the clathrate forming agent.

FIG. 2 is a diagrammatic block diagram of a crystallizer using a transducer coupled to a cage of silica gel particles.

FIG. 3 is a diagrammatic cross-sectional side view of an embodiment of a wash column.

FIG. 4 is a phase diagram for carbon dioxide and seawater.

FIG. 5 is a diagrammatic block diagram of the major components of an exemplary seawater clathrate formation system using pressurized carbon dioxide as the clathrate forming agent.

### DESCRIPTION OF THE EXEMPLARY EMBODIMENTS

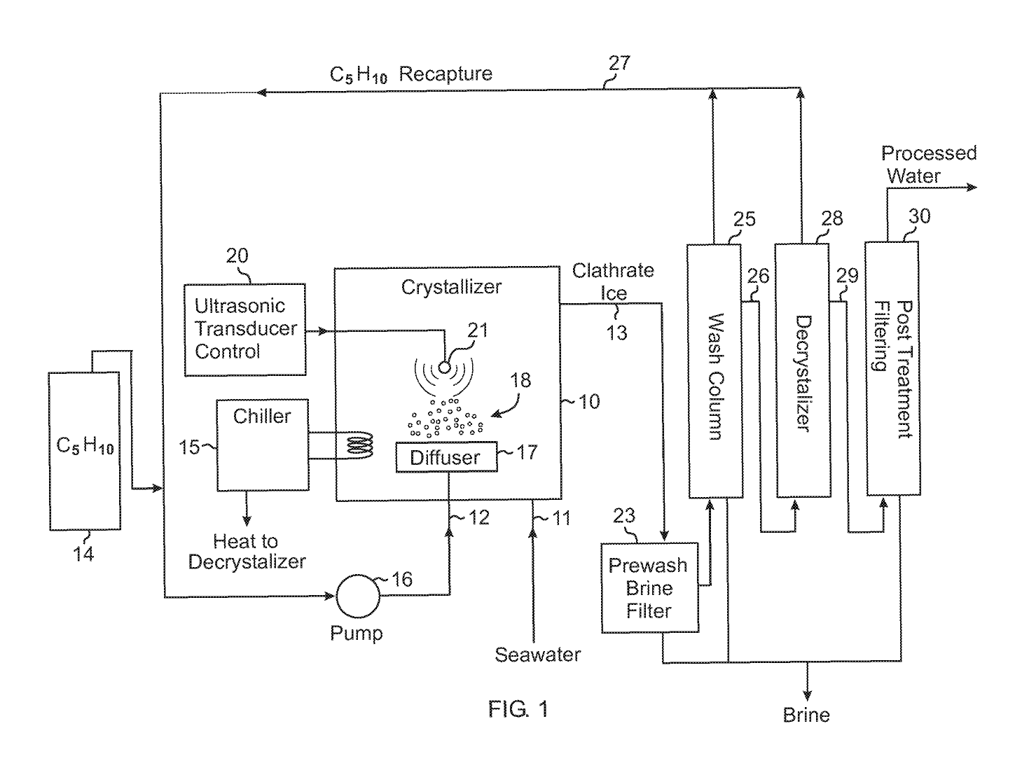

Referring now to the drawing, there is shown in FIG. 1, a system block diagram of the major components of gas hydrate as a clathrate freeze desalination system which uses cyclopentane (“C₅H₁₀”) as a clathrate forming agent. The system includes a reactor vessel called a crystallizer 10 which receives a flow of seawater 11 and a flow of C₅H₁₀ gas 12 from a C₅H₁₀ gas source 14, and produces a flow of clathrate ice 13. The clathrate ice is a frozen, crystallized hydrate of C₅H₁₀ in clathrate form.

In the crystallizer 10, the required temperature and pressure are maintained to encourage the hydrate formation to occur according to the phase diagram for cyclopentane and seawater. A chiller 15 is used to reduce the temperature of the seawater inside the crystallizer to about 8 degrees centigrade. Excess heat generated by the chiller is sent to the decrystalizer described below. The C₅H₁₀ gas 12 is injected into the crystallizer 10 by a pump 16.

The clathrate forming gas 12 is injected through an internal diffuser 17 that allows for a more uniform distribution of the C₅H₁₀ gas as very small bubbles 18, having an average diameter of preferably between about 10⁻³ and 10⁻² millimeter. This encourages dispersion of C₅H₁₀ in the vessel to provide a greater number of nucleation sites for clathrate formation. Movement of the bubbles further encourages agitation of the seawater and more thorough mixing.

A controller 20 directs the activation of an ultrasonic transducer 21 located in the crystallizer vessel. The transducer imparts ultrasonic kinetic energy into the chilled mixture of seawater and C₅H₁₀ gas to further encourage nucleation and thus clathrate formation. The transducer can be set to vibrate at an ultrasonic frequency of between about 30 KHz and about 50 KHz. The power of the transducer will depend on the volume of the vessel and the structure of the vibrating surfaces of the transducer and its proximity to the stream of gas bubbles.

The transducer can be of a commonly available commercial type transducer having a vibrational element having an actuator sufficient to impart vibrational energy at the appropriate frequency within the stream of bubbles. The dimensions of the transducer are selected depending on the volume and dimensions of the crystallizer vessel. However, because of the low compressibility of liquid seawater, a single transducer of 100 Watt power has be found adequate for a vessel having a volume of about 0.5 cubic meter. The power level is readily scalable for larger vessels.

The transducer can be located within the stream of bubbles. Further, the surface area of the transducer can be increased to bring the transducer surfaces closer to the bubbles and for a longer duration as the bubble stream flows past.

It is important to note that the ultrasonic transducer is preferably not a mechanical stirrer or other fluid flow inducing element, but rather is strictly a non-flow inducing, substantially locationally static, vibration imparting element. In other words, although the transducer vibrates and thus moves, it has no elements which flow through the liquid medium into which it is immersed, or elements which induce any substantial flow in the liquid medium.

A larger dimensioned transducer and/or a greater number of transducers spaced apart within the vessel can be used to impart a more powerful or uniformly dispersed vibrational energy.

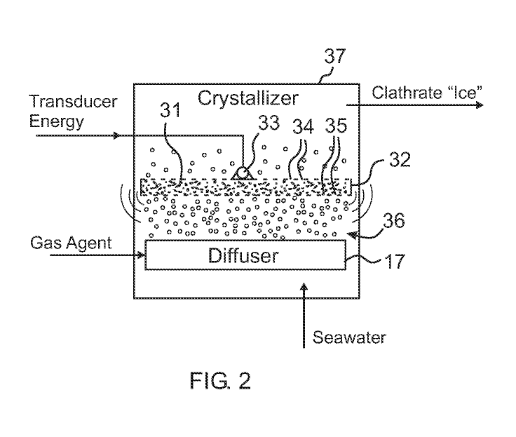

Further, as shown in FIG. 2, an amount of silica gel 31 or other particulate solid material can be added to the chilled mixture of seawater and C₅H₁₀ gas to further increase the surface area within the vessel 37 and help catalyze nucleation. The solid particulate material can be placed in contact with the transducer 33 by loading the material in a cage structure 32 mounted to the transducer. The cage structure can have an array of upper and lower apertures 34,35 shaped to both contain the particulate material and allow passage of the bubble stream 36 emanating from the diffuser 38 therethrough. It shall be noted that the diffuser 38 can be shaped to substantially fill the cross-diameter of the crystallizer vessel in order to maximize the use of the available volume for clathrate formation. Similarly, the structure holding the silica gel particles can be commensurately shaped and dimensioned to the diffuser so that substantially the entire stream of bubbles can be addressed.

The formed clathrate ice 13 is pulled from the crystallizer 10 and then passed through a prewash brine filter 23 before being sent to a wash column 25 where the clathrate is washed of brine residue 24 using a fresh water washing liquid. Unused C₅H₁₀ is captured and routed 27 back to the pump 16 for reintroduction into the crystallizer.

The washed clathrate crystals 26 are fed to a de-crystallizer 28 where they are melted thus extracting fresh water 29 and C₅H₁₀ which is recaptured and routed 27 back to the source 14 or reintroduction into the crystallizer 10. The energy for the melting process can be provided by the condenser of the cooling system such as the chiller 15 and heat recovery from other mechanisms. The fresh water can be sent through an optional post treatment filtering 30 such as through activated carbon to remove any residual taste from the original raw seawater used in the process. The desalination accomplished can accept seawater having a salinity of 35,000 ppm and produce fresh water having a salinity of less than 500 ppm, or a factor of at least 70.

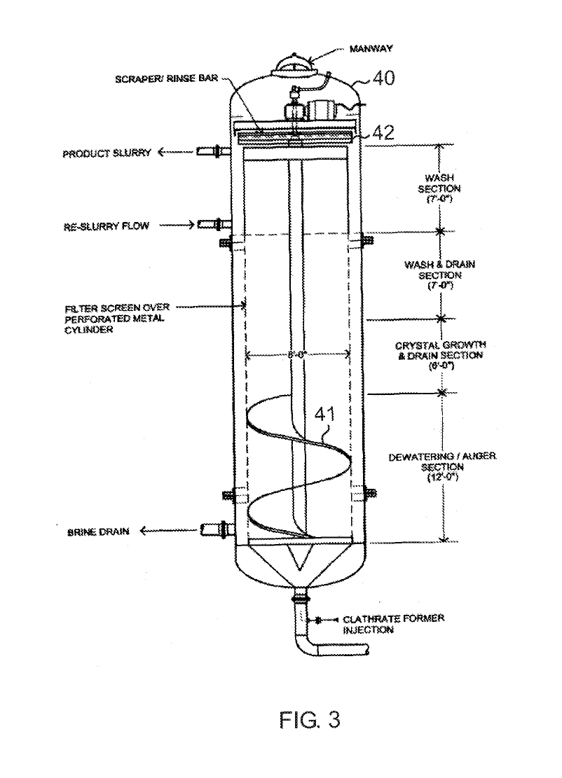

Referring now to FIG. 3, there is shown a diagrammatic cross-sectional diagram of the wash column 25 including a vessel 40 which has an internal displacement device 41 in the form of an Archimedes Screw that pushes the solid clathrate ice up the vessel where a scraper and rinse bar 42 capture and clean the crystals. The crystal growth section can house a toroidal or washer shaped diffuser, transducer structures, and silica gel particle containing structures. Alternately the screw can be located in the upper section of the vessel to scrape off clathrate ise without disturbing lower sections where formation occurs.

One advantage of the present system using C₅H₁₀ is that clathrate formation can occur at sea level atmospheric pressures using readily attainable temperatures. The nucleation enhancing elements described above thus allow for the use of inexpensive and environmentally controllable cyclopentane as the clathrate forming gas.

### Example 1

The seawater in the crystallizer having a volume of about 0.5 cubic meter was kept at a temperature of about 8 degrees Centigrade. The pressure was kept between about 0.9 and 1.1 Atmospheres. A flow of C₅H₁₀ gas of between about 40 and 50 Grams per second was injected into the crystallizer under a pressure of between about 1.5 and 2.5 Atmospheres. The ultrasonic transducer was activated to vibrate at between about 30 and 50 Kilohertz, and a power level of between about 5 and 100 Watts. This formed C₅H₁₀ clathrate at an estimated rate of between about 2×10⁻⁶ and 4×10⁻⁶ Grams per second per Gram of seawater.

Although there are significant cost and engineering advantages to using C₅H₁₀, other gases may also be used including CO₂, and gaseous hydrocarbons such as CH₄, C₂H₆, C₃H₈, and C₄H₁₀ and mixtures thereof.

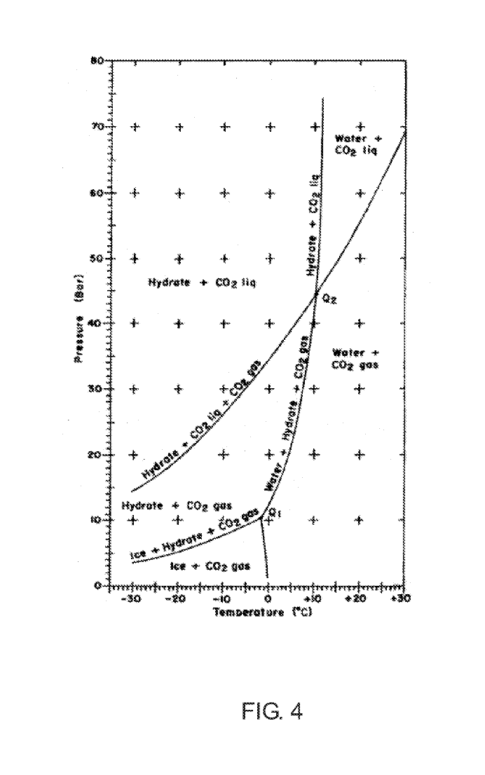

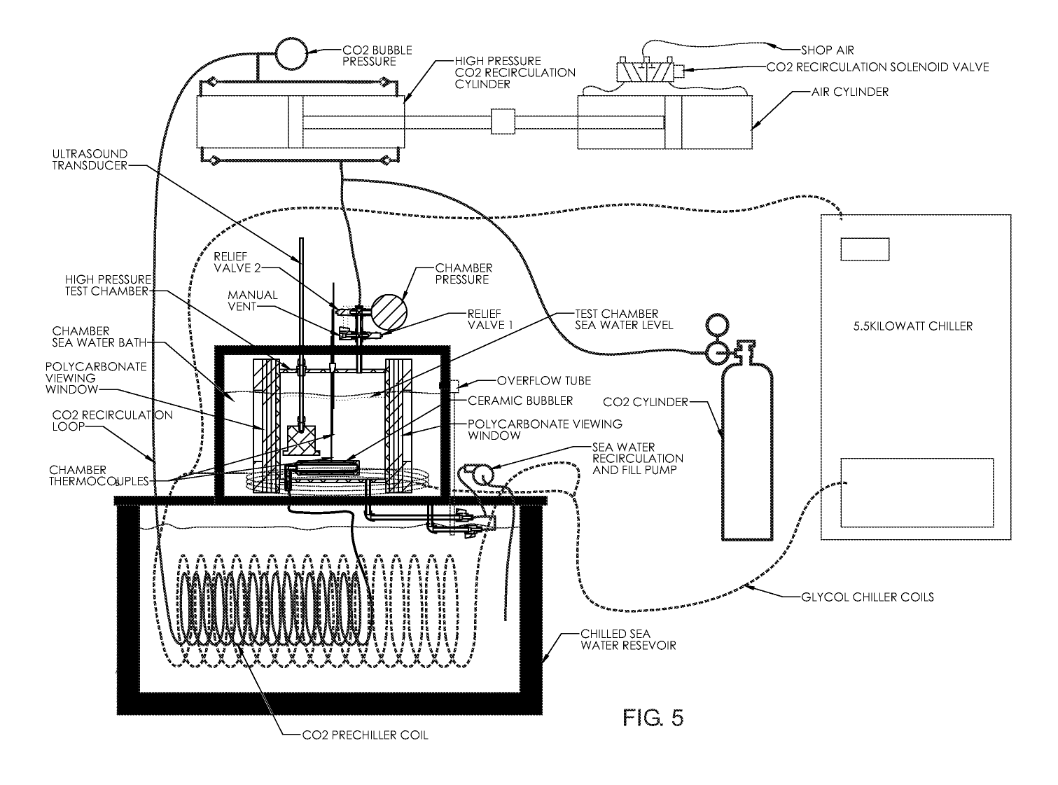

Referring now to FIGS. 4 and 5, there is shown a clathrate forming system using pressurized CO₂. FIG. 4 shows the phase diagram for seawater and CO₂.

As shown in FIG. 5, there is a block diagram showing the major components of an embodiment of the clathrate formation system using pressurized CO₂ as the clathrate forming agent system with appropriate descriptive labeling shown. The high pressure can be generated within the reaction vessel or, alternately, the CO₂ can be pressurized and injected into a rising column of extracted deep ocean water as disclosed in my patent, U.S. Pat. No. 5,553,456, incorporated herein by reference.

### Example 2

The following is an example using CO₂ as the clathrate forming gas. The seawater in the crystallizer having a volume of about 0.5 cubic meter was kept at a temperature of between about −1.5 and −0.5 degrees Centigrade. The pressure was kept between about 14 and 16 Atmospheres. A flow of CO₂ gas of between about 40 and 50 Grams per second was injected into the crystallizer under a pressure of between about 16 and 18 Atmospheres. The ultrasonic transducer was activated to vibrate at between about 30 and 50 Kilohertz, and a power level of between about 5 and 100 Watts. This formed CO₂ clathrate at an estimated rate of between about 2×10⁻⁶ and 4×10⁻⁶ Grams per second per Gram of seawater.

While the preferred embodiment of the invention has been described, modifications can be made and other embodiments may be devised without departing from the spirit of the invention and the scope of the appended claims.

What is claimed is:

1. A method for desalination of water comprises:
providing an amount of seawater;
cooling said amount to a phase which allows for clathrate formation;
injecting a dispersed clathrate-forming gas agent into said amount;
imparting ultrasonic energy into said amount;
collecting clathrate crystals from said amount; and,
melting said crystals to form an amount of fresh water.

2. The method of claim 1, which further comprises augmenting said amount with a flow of additional seawater.

3. The method of claim 1, wherein said injecting occurs through a gas diffuser to create a stream of bubbles of said gas agent.

4. The method of claim 1, wherein said imparting comprises locating and activating an ultrasonic transducer within said amount.

5. The method of claim 3, wherein said imparting comprises locating and activating an ultrasonic transducer within said stream.

6. The method of claim 4 or 5, wherein said activating comprises operating said transducer at a frequency of between about 30 and 50 Kilohertz.

7. The method of claim 3, which further comprises placing an amount of solid material particles within said stream.

8. The method of claim 7, wherein said solid material particles comprises silica gel particles.

9. The method of claim 7, wherein said imparting comprises locating and activating an ultrasonic transducer within said stream; and, wherein said method further comprises:
carrying said particles within a structure mounted to said transducer; wherein said structure comprises an array of apertures sized and shaped to contain said particles and allow passage of a portion of said stream therethrough.

10. The method of claim 1, wherein said collecting comprises washing said crystals to remove residual seawater therefrom.

11. The method of claim 1, wherein said melting comprises using residual heat generated by a compressor or chiller device associated with said apparatus.

12. The method of claim 1, wherein said gas is selected from the group consisting of CO₂, CH₄, C₂H₆, C₃H₈, C₄H₁₀ and C₅H₁₀ and gaseous mixtures thereof.

13. The method of claim 1, wherein said cooling comprises prechilling an amount of cyclopentane by circulating it through a conduit exposed to an amount of chilled seawater.

14. A clathrate freeze desalination apparatus comprises:
a crystallizer reaction vessel;
an amount of seawater located in said crystallizer;
a source of clathrate forming gas; and,
an ultrasonic transducer located to impart sonic energy upon said amount located within said vessel.

15. The apparatus of claim 14, wherein said gas is selected from the group consisting of CO₂, CH₄, C₂H₆, C₃H₈, C₄H₁₀ and C₅H₁₀ and gaseous mixtures thereof.

16. The apparatus of claim 14, wherein said amount is augmented by a flow of seawater into said vessel.

17. The apparatus claim 15, which further comprises:
a diffuser connected to said source and adapted to form said gas into a stream of bubbles.

18. The apparatus claim 17, which further comprises:
said diffuser being further adapted to generate bubbles in said stream having a mean diameter of between about 10⁻³ and 10⁻² millimeter.
